(19) United States
(12) Patent Application Publication
(10) Pub. No.: US 2007/0222234 A1
(43) Pub. Date: Sep. 27, 2007

(54) Button mechanism for a night latch for a sliding member

(76) Inventors: Luke Liang, South Plainfield, NJ (US); Tong Liang, Guangzhou (CN); David Chen, Guangzhou (CN)

Correspondence Address: Thomas A. O'Rourke;Bodner & O'Rourke, LLP, 425 Broadhollow Road, Melville, NY, 11747, US

(21) Appl. No.: 11/402,213

(22) Filed: Apr. 11, 2006

Related U.S. Application Data
(63) Continuation-in-part of application No. 11/388,786, filed on Mar. 24, 2006.

(51) Int. Cl. E05C 17/44

(52) U.S. Cl. 292/338

(57) ABSTRACT

The present invention relates to a night latch in particular a night latch that includes a housing, a tumbler, a button, and one resilient member. The housing, tumbler and resilient member of the present invention all serve the same function and operate in the same manner, as in our previously filed U.S. patent application filed on Mar. 27, 2006, Ser. No. 11/388,786. That is to say the housing houses the members, the tumbler prevents movement of the sliding member, and the resilient member forces the tumbler into an exposed position. In the present invention the improved button forces the tooth-like protrusion into the recess of the tumbler in a similar fashion as in our previously filed patent application. However, unique to the present invention, is a flexible bottom portion integral with the button, which biases the tooth-like protrusion of the button into the recess of the tumbler. Hence, the use of a separate biasing member is unnecessary.

The present application is a continuation-in-part of previously filed U.S. patent application Ser. No. 11/388,786 filed on Mar. 27, 2006, as the disclosures of which are hereby incorporated by reference. The present invention relates to a night latch, in particular to a night latch that may be used in a sliding window or sliding door, which implements an improved button mechanism used for activating the night latch.

### BACKGROUND OF THE INVENTION

1. Field of Invention

Double hung windows are a common type of window used in many homes and remodelings. There is a frame with a pair of tracks on each side of the frame. There is a top sash and a bottom sash. The top sash typically rides in the outer tracks, i.e. the tracks in the frame closest to the outside of a building. The lower sash rides in the inner track, i.e. that track that is closest to the interior of a house. The sash has a pair of vertical stiles that are joined to upper and lower horizontal stiles. One or more panes of glass are retained in the sash. There can be an inner pane and an outer pane that extends from one vertical stile to the other and from one horizontal style to the other. There can be a third pane of glass positioned similarly with a gap between the first and second panes. The gap is usually filled with an inert gas such as argon. This structure provides a window with insulating qualities. One or more muntin bars can be present to provide a look of individual lights in the window of the type that are found in older construction.

In many double hung windows there is an issue of security. There is usually an outer screen that permits cooler air to ventilate into the house during the warmer months. In order to take advantage of the screen however, the bottom pane typically must be in a raised position. Double hung windows are usually provided with a sash lock that locks the lower and upper sash in position so that they cannot be opened from the outside. While this provides some security during the cooler months, the return of warm weather may make it difficult to use the sash lock in many instances. The sash lock has two positions, a locked position and an unlocked position. Thus the resident has a choice to either keep the window in a closed locked position or have the window sash unlocked and thus open to intruders.

In order to provide a means of ventilating a room yet provide some security, there have been a number of night latches and vent stops that have become available in the market. One such sash stop is U.S. Pat. No. 5,248,174 owned by Ashland Products. Another type of sash stop U.S. Pat. No. 4,923,230, owned by Ro Mai. These night latches or vent stops act in a similar fashion. The night latch or vent stop is placed in the face of the upper sash. Depending on the desired amount of ventilation, the night latch can be placed at any position on the face. Once the night latch is secured in the face of the window, the tumbler can be pressed in an inward and upward fashion activating a spring mechanism that will force the tumbler to an exposed position, thus creating the impeding force required to restrict movement of the lower window sash. Other prior art vent stops are U.S. Pat. Nos. 5,553,903 and 5,806,900 both of which are owned by Ashland.

As mentioned previously, the typical prior art vent stop prevented the opening of the lower sash in similar fashions. In the typical prior art the tumbler was held in a locked position via a catch portion located in the housing of the night latch. Thus, if inwardly and upwardly forces were applied perpendicularly to the face of the tumbler, these forces would free the tumbler from its locked, inactivated position, to its unlocked, activated position.

While the tumblers in the prior art night latches are capable of preventing the sliding member from moving passed a certain predetermined position, these tumblers have an unfavorable characteristic. That is in the prior art vent stop, in order for the user to free the tumbler from its inactivated position to its activated position or vice versa, the user must apply a multitude of forces in a variety of different angles.

Although the night latch and/or vent stops are capable of preventing the lower sash from moving passed a certain desired position, their utility is unfortunately outweighed by their inherent clumsy composition. The night latch in the present invention improves on the prior art shortcomings by implementing a unique method of activating and inactivating the tumbler from the housing, without taking away from its utility and its aesthetic quality. In addition, the invention implements an improved button, which is used for activating the tumbler of the night latch of the present invention.

2. Objects of the Invention

It is an object of the present invention to provide a night latch that operates more easily than the prior art night latches.

It is an object of the present invention to provide an improved night latch that is more reliable in its operation than the prior night latches.

It is an object of the present invention to provide a night latch that allows the user to more readily reposition the tumbler back in an inactivated position.

It is still another object of the invention to allow the user the ability of activating the tumbler without the use of multiple forces to release the tumbler.

It is a still further object of the present invention to provide for a more durable night latch, so as to allow for a longer period of operability.

It is still a further object of the present invention to produce a night latch with a superior button mechanism, in particular a button that does not require a separate spring to bias the protrusion of the button into the recess of the tumbler.

These and other objects of the present invention will become apparent to those skilled in the art from a review from the description provided below.

### SUMMARY OF THE INVENTION

The present invention is an improved night latch or sash controlling mechanism. The improved night latch can be used with a variety of windows and doors, including, but not limited to, single hung windows, double hung windows, sliding windows and doors, etc. The windows can be of the type that moves vertically or horizontally. If the windows are to move in a vertical fashion then the windows will have upper and lower sashes situated in the frame of the windows. If the windows are to move horizontally, then the windows will have right and left sashes situated in the window's frame. A night latch for a sliding door can be installed and operated in the same manner as the sliding window, except the door will sit in the door frame rather than a window frame. More specifically, this invention is directed to be an integral part of a sliding window or door, that is simple, inexpensive, and ergonomically superior to the prior art.

The present invention, as mentioned previously, is a continuation-in-part of previously filed United States patent application filed on Mar. 27, 2006 Serial #, and as such all disclosures of which are hereby incorporated by reference. The night latch of the present invention has three primary components, as in the applicants previously filed patent application, a tumbler, a button, and a housing that will accommodate the tumbler and the button. The housing is placed in a groove or recess on the face of the upper window sash. The housing is constructed so as to make for a tight, smooth, and finished appearance when inserted into the groove of the window sash. This fit will make for an aesthetically pleasing appearance.

As in the applicant's previously filed application #, a tumbler is generally used as the stopping mechanism in the night latch. In general, the tumblers of other prior art are activated by applying an outside force in a multitude of ways directly to the tumbler, making for a rather difficult and sometimes impossible task. One example of this is when the spring inside the tumbler is new and rather tight. In the present invention the tumbler is activated via an improved separate button, located on the housing of the night latch. This allows the user to activate the tumbler with relative ease. The force applied can be in a downward motion, as in the present invention, or the force applied can be in an inward motion. The direction of the force applied depends on how the button is configured.

In addition to the relative ease of operation of the improved night latch, the improved night latch has an active cover located either on the bottom of the housing, or on the side, which allows for installing parts inside of the housing. In the prior art the housing is open, thus exposing the inside parts, such as the tumbler and spring, to the outside weathering elements, such as moisture in the air, which could cause malfunction of the night latch, i.e. a rusty spring. In the present invention the active cover acts as a barrier, so as to impede the destructive nature of weathering.

Moreover, the night latch of the present invention can be deactivated with even less effort than the prior art. If the user wished to close the night latch in the prior art, the user would have to exert an inward and downward force to deactivate the night latch. This is because the tumbler in the prior art is kept depressed via the face of the tumbler and the top plate of the housing. As mentioned previously application of these forces can prove to be rather burdensome when the night latch was fairly new. In the present improved night latch, the only force needed is a downward force; this is because of the co-action between the tensed bottom protruding portion of the button and the bottom recess portion of the tumbler. The protruding portion of the button keeps the tumbler in a locked inactivated position.

The button in the present invention improves on the button of our previously filed United States patent application filed on Mar. 27, 2006 Serial #. The button in the present invention does not implement a torsion spring. In our previously filed patent application a torsion spring was implemented, which biased the protrusion of the button into the recess of the tumbler. With the present button configuration the use of a separate spring has been rendered unnecessary do to the advanced button design. In the present invention the bottom portion of the button is designed to be of such resilient nature, so as to act as a tumbler retainer when the tumbler is not in an activated position.

### BRIEF DESCRIPTION OF THE DRAWINGS

FIG. 1 is a perspective view of the night latch of the present invention set in a window frame with the tumbler exposed.

FIG. 2 is a side exploded view of the night latch of the present invention with the cover not attached.

FIG. 3 is a rear end view of the night latch of the present invention with the tumbler exposed.

FIG. 4 is a side view of the night latch of the present invention with the tumbler exposed.

FIG. 5 is side cut out view of the night of the present invention with the tumbler exposed.

FIG. 6 is a top side cut out view of the night latch of the present invention with the tumbler exposed.

FIG. 7 is a side cross-sectional view of the night latch of the present invention with the tumbler in a retracted position.

FIG. 8 is a side cross-sectional view of the night latch of the present invention with the tumbler exposed, without guide members.

FIG. 9 is a side cross-sectional view of the night latch of the present invention with the tumbler exposed, and the button released from the housing, without guide members.

FIG. 10 is a perspective view of the improved bottom of the night latch of the present invention.

FIG. 11 is an exploded view of the tumbler and the spring of the night latch of the present invention.

### DETAILED DESCRIPTION OF THE INVENTION

As required, detailed embodiments of the present invention are disclosed herein; however, it is to be understood that the disclosed embodiments are merely exemplary of the invention, which may be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure.

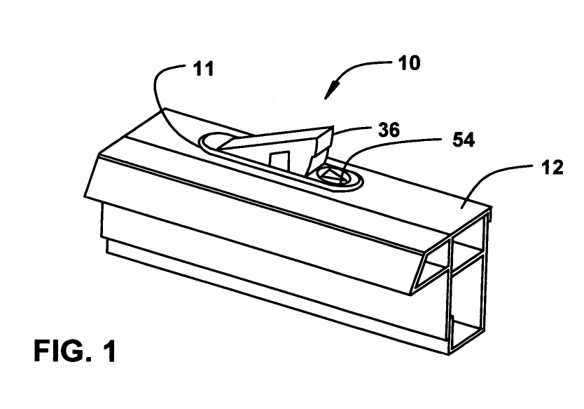

In FIG. 1, the night latch of the present invention is shown generally at 10. Night latch 10 is shown positioned inside slot 11 in stopping member 12. The slot 11 is shown as having an oval shape, but any other suitable shape and size slot including but not limited to a square, rectangle, oval, etc. can be used depending on the shape of the latch. Preferably however, the night latch 10 of the present invention will have a housing portion similarly shaped to slot 11 as to present a clean appearance when placed in the stopping member 12. In the present embodiment an oval shape was implemented for illustration purposes. The stopping member can be a sash, doorframe, or any other member that has another piece sliding over it, where restriction of the sliding member is desired. Tumbler 36 can be in either a raised or in a lowered position. When raised it prevents movement of the door or sash

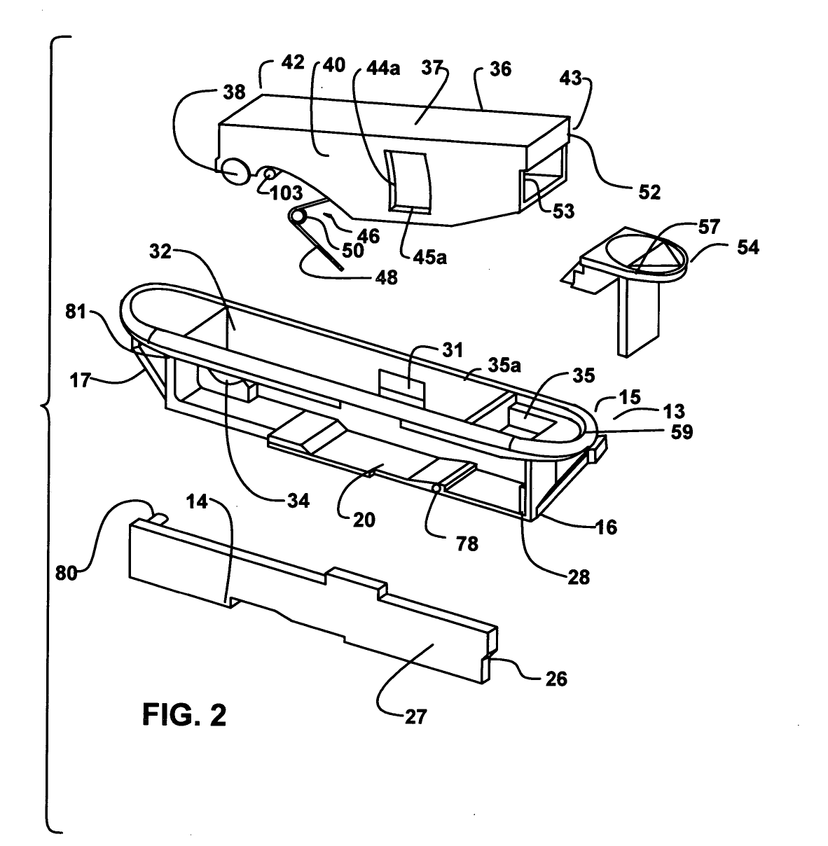

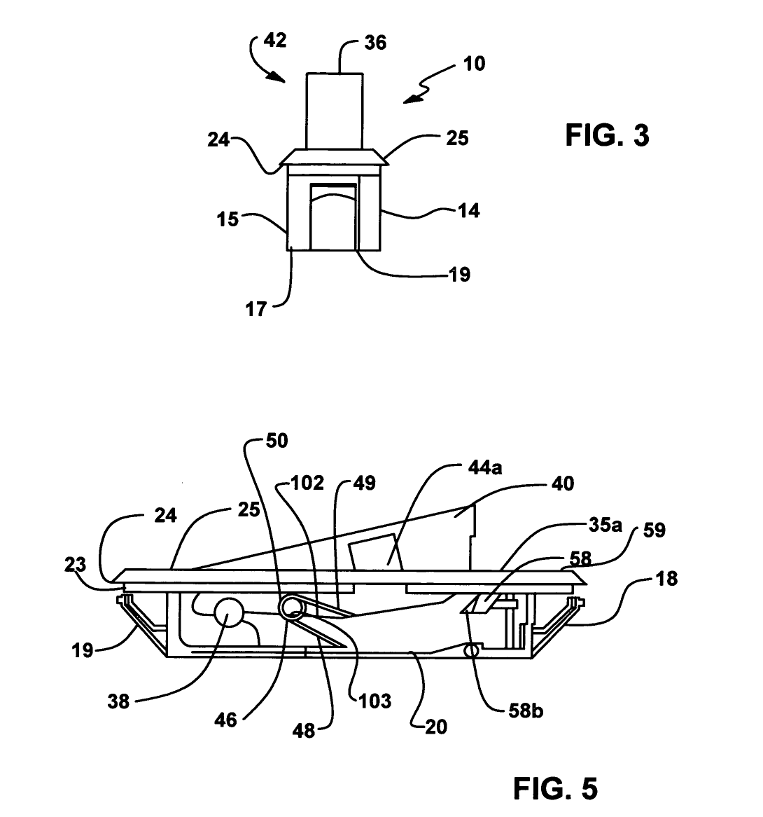

FIG. 2 is a more detailed view of the contemplated night latch. A housing 13 is generally defined by a first and second sidewall, 14 and 15 respectively, and a front and rear wall, 16 and 17 respectively. It is noted that the terms “front” and “rear” are used only for descriptive purposes and do not read on orientation of the device. Sidewalls 14 and 15 are preferably the same length, as are front and rear walls 16 and 17, respectively, providing for a generally rectangular shape to housing 13. Preferably, when in place within slot 11, sidewalls 14 and 15 contact the edges of slot 11 to provide for a tight fit, and prevent a lateral movement of the night latch 10 within slot 11. In addition, sidewalls 14 or 15 can be detachable so as to act as cover plates for accessing housing 13. In the present embodiment sidewall 14 acts as a detachable cover plate, as seen in FIG. 2. In another embodiment one may implement a separate cover plate that can be placed near the front end of housing 13.

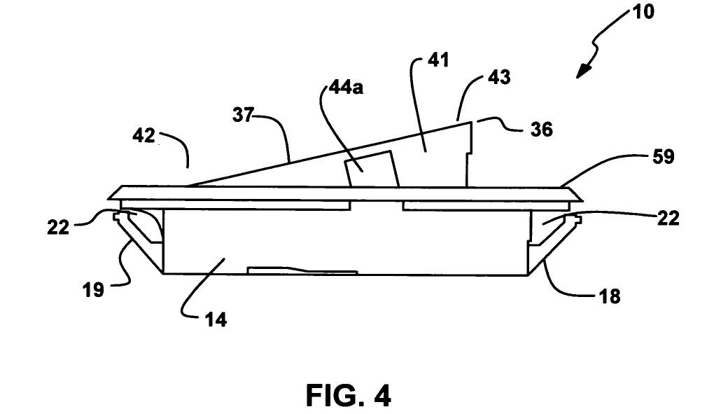

Front wall 16 can have a front flexible clip 18 and rear wall 17 can have a rear flexible clip 19, as seen in FIG. 4. Each clip may extend generally in an upward fashion, originating at or near bottom surface 20 of housing 13, and may end just below top plate 25. In the present embodiment each clip creates a notch 22 between a lip 23 on bottom surface 24 of top plate 25, also seen in FIG. 4. When night latch 10 is depressed into slot 11 on a stopping member 12, each notch 22 can engage a portion of the stopping member 12. This engagement can prevent vertical (front and back) movement of night latch 10 within the stopping member 12, as well as preventing night latch 10 from being easily dislodged from slot 11.

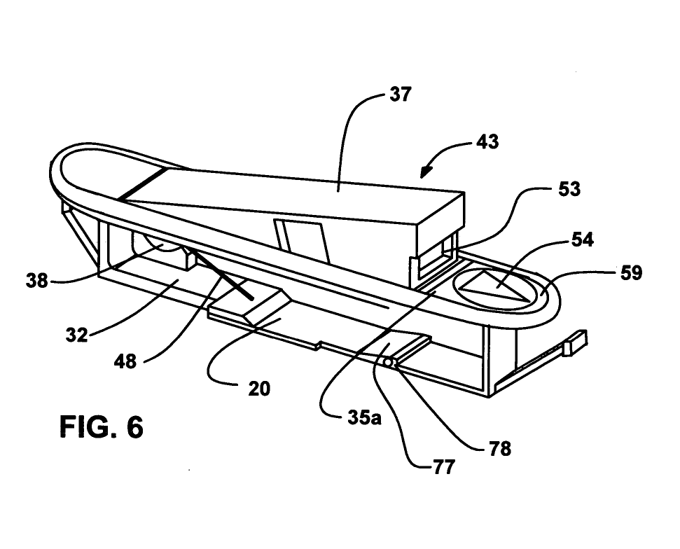

First sidewall 14 has an inner surface 26 and outer surface 27. Second sidewall 15 has inner surface 28 and outer surface 29. The inner surfaces 26 and 28 can have two protrusions 30 and 31 respectively that act as guide members for tumbler 36. This can be accomplished by setting protrusions 30 and 31 into cavity 32 located inside housing 13, as seen in FIG. 6. In addition to acting as guide members for tumbler 36 protrusions 30 and 31 acts as a limiting device for tumbler 36, i.e. tumbler 36 will extend out only the distance allowed by the coaction between protrusions 30 and 31 and grooves 44(a) and 44(b) of tumbler 36. The shape of the protrusions, 30 and 31, can be of any suitable shape including but not limited to a square, rectangle, circle, etc. In the present embodiment protrusions 30 and 31, and their respective grooves, 44(a) and 44(b) are of rectangular shape. Walls 14 and 15 also can have two circular areas, 33 and 34 respectively, positioned towards rear wall 17. Circular areas 33 and 34 are aligned along the same central axis. These circular areas are designed so as to allow tumbler 36 to rotate from a recessed position to an outwardly position. The circular areas can be any suitable circular areas known in the art including, but not limited to apertures, bores, cavities, and the like. In the present embodiment circular areas, 33 and 34 are a bore and an aperture respectively. Bored area 33 on wall 14 can be enlarged so as to allow greater contact with axle 38, this can be achieved by affixing a hollowed out extension of bored area 33 that surrounds a partial portion of outside perimeter of bored area 33, not shown. As mentioned previously one can also have two apertures instead of one aperture and one bored hole, as seen in FIG. 2.

The lip 23 attached to top plate 25 is preferably at least the same size or larger and the same general shape as slot 11. Thus, when night latch 10 is placed into slot 11, lip 23 will contact at least the edges of slot 11, or over spread the upper surface of the stopping member 12. These dimensional attributes will allow for a tight fit that will exhibit a finished smooth exterior, which can be aesthetically pleasing. Although top plate 25 is referred to as a “plate”, it is understood that housing 13, clip 18, lip 23 and top plate 25 can be integral pieces, without any need for adhesives or assemblage.

A tumbler 36 is preferably designed to fit within cavity 32 of housing 13. Tumbler 36 may have an upper surface 37, which is preferably smooth and/or flat, as seen in FIG. 11. A flat surface 37 will exhibit a more finished look for night latch 10 when it is placed in stopping member 12. Tumbler 36 can have a front end 43 and a rear end 42, along with side surfaces 40 and 41. In addition, tumbler 36 can have a rotation member 38 located on rear end 42 that extends from side surface 40 to side surface 41 on tumbler 36. Rotation member 38 can fit into areas 33 and 34. Rotation member 38 can be any suitable structure known in the art including but not limited to a peg, axle, pin, etc. Furthermore, rotation member 38 can be two separate members affixed to tumbler 36, such as two cylindrical pegs attached to side surfaces 40 and 41 respectively. In the present embodiment rotation member 38 is single axle. In addition rotation member can be part of tumbler 36, or rotation member 38 can stand alone. In the present embodiment rotation member 38 is a part of tumbler 36. By setting rotation member 38 into corresponding areas 33 and 34 will allow tumbler 36 to pivot within cavity 32, and thus rotate from a recessed position to an extended position and have a portion exposed above the surface of stopping member frame 12.

In addition to having rotation member 38, tumbler 36 also has two arcuate grooves 44(a) and 44(b) located on side surfaces 40 and 41 respectively. Grooves 44 (a) and (b) can house guide members 30 and 31, of sidewalls 14 and 15 respectively, and thus provide an arcuate path for tumbler 36 about axis of rotation member 38. Furthermore, grooves 44 (a) and (b) and guide members 30 and 31 can act as a restricting device for tumbler 36, as mentioned previously. When tumbler 36 is in an activated position guide members 30 and 31 contact the bottoms of 45 (a) and (b) of grooves 44 (a) and (b), this interaction will lock guide members 30, 31, and bottoms 45 (a) and (b), which will cause tumbler 36 to lock into an exposed position, thus exposing the stopping surface 52, which will act as to prevent the sliding member from moving beyond a certain predetermined position.

Tumbler 36 has a bored area 100, which can be placed on either side of tumbler 36, as seen in FIG. 5. In the present embodiment bored area 100 is located toward the rear end of side surface 40 of tumbler 36. Bored area 100 has a wall 101, not shown, that extends tangentially from plane 102, not shown, to side surface 40. In addition, bored area 100 has a circular shaped protrusion; any suitable circular shaped protrusion known in the art can be implemented including, but not limited to a peg, pin, and the like. In the present embodiment a cylindrical peg 103 that extends tangentially the exact distance of wall 101 was implemented.

The force that causes tumbler 36 to rotate in an outwardly fashion, can be created by a spring. Any spring known in the art including, but not limited to coil, helical, torsion, etc. can be used. In the present embodiment, a coil spring 46 was implemented. Spring 46 has three members; the first is a coiled portion 50 that rests on cylindrical peg 103, as seen in FIGS. 2 and 5. The second member is elongated portion 48, which exerts a constant force on the inside bottom surface 20 of housing 13 and a third member, elongated portion 49, which exerts a constant force on wall 101 in bored area 100 of tumbler 36. The tension created by elongated portions 48 and 49 is of such a nature that the tension will be greater when tumbler 36 is depressed so as to push tumbler 36 in an outwardly fashion when button 54 is triggered.

Front end 43 of tumbler 36 can have a stopping surface 52. When exposed, stopping surface 52 will prevent movement of a sliding frame or member intending to slide over night latch 10. Stopping surface 52 can also have a cavity portion 53, which is a hollowed portion of front end 43 of tumbler 36. Cavity 53 is of such dimensions so as to allow entry of protruding portion of button 55. In addition, cavity 53 should be of such dimensions so that the integrity of tumbler 36 will not be compromised by the frequent contact of a sliding member

The release of tumbler 36 from housing 13 can be controlled by an interaction between a button 54. Button 54 can have a top surface 56 which can be in the same plane as upper surface 37 of tumbler 36. Button 54 can reside in opening 35 of top plate 25. Top surface 56 of button 54 can be designed to have the same shape as opening 35 of top plate 25, however, any suitable shape known in the art including, but not limited to square, rectangle, circle, or any combination thereof. In the present embodiment, because of the rectangular look of the night latch 10, opening 35 has a rectangular rear section and circular front tip portion. The top surface 56 of button 54 has the same basic look as opening 35, except that top surface 56 is smaller in proportion, so as to allow movement inside opening 35. Here, the user can access the button 54 easily. Top surface 56 of button 54 can have a groove 57, which the user can engage with a finger, fingernail, pen, pencil, etc. or any other suitable instrument known in the art. Button 54 can be designed to move in different ways, any suitable movement known in the art but not limited to sliding, depression, etc. In the present embodiment button 54 was designed to slide in an up and down manner, within opening 35. When the night latch is not activated, i.e. tumbler 34 is depressed; the top surface 56 of button 54 will rest toward the rear end 35a of opening 35 of top plate 25. When the user wishes to activate night latch 10, the user will apply a downward force to groove 57, which will cause the top button 56 to slide toward the front end 59 of opening 35, as seen in FIGS. 4 and 6.

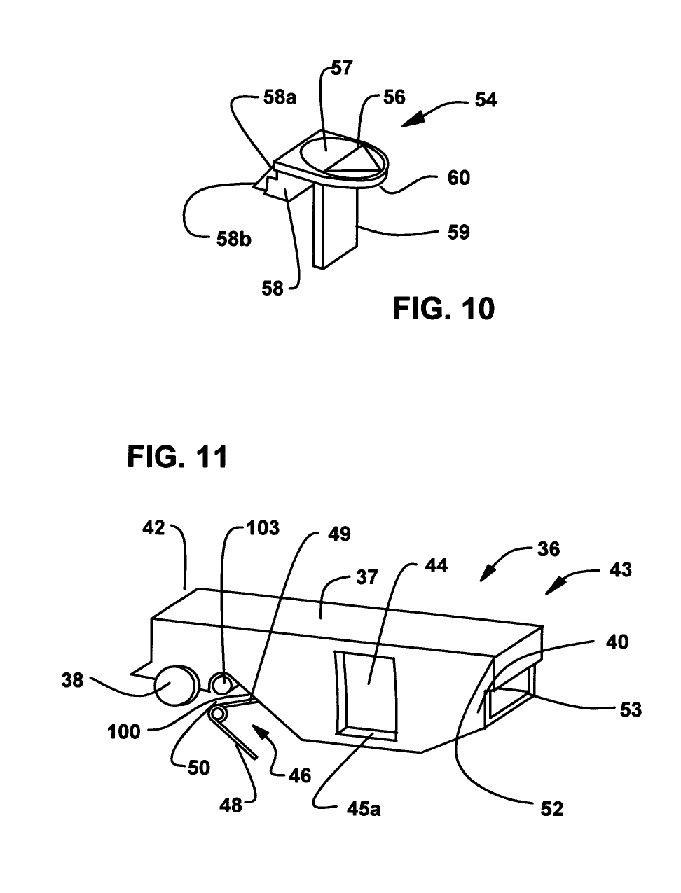

Improved button 54 of the present invention will now be discussed in greater detail. Drawing one's attention to FIG. 10 one can see the button of the night latch of the present invention. Button 54 as mentioned previously may have a top surface 56 and a groove 57. In addition, button 54 may be manufactured from any suitable material known in the art including, but not limited to resins, plastic and the like. In the preferred embodiment one manufactured button 54 out of a plastic polymer. This type of material was preferred, because of its resilient nature. In addition to having portions 56 and 57, button 54 may also have a left portion 58 and a right portion 59.

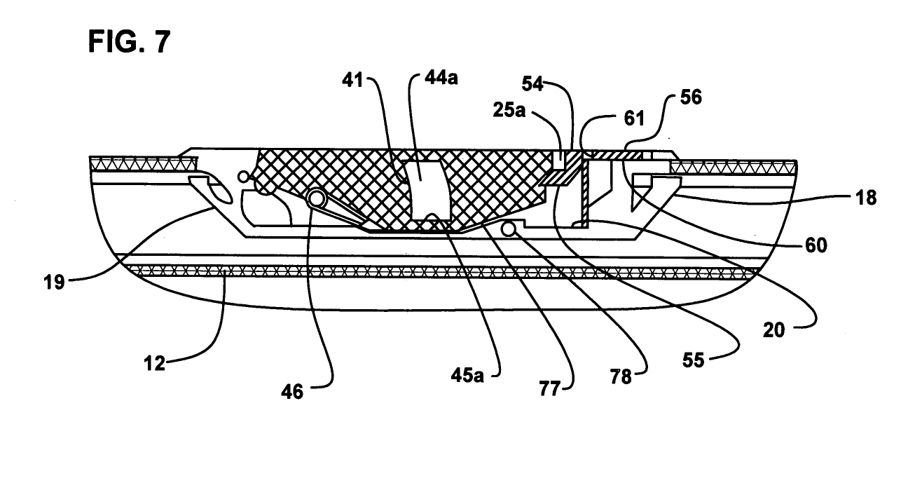

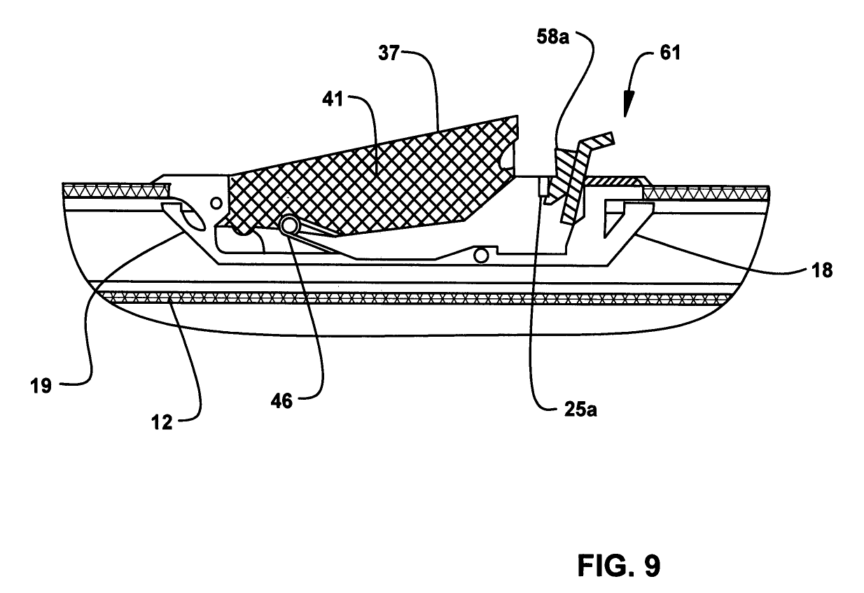

Portion 58 may be generally rectangular in shape, which may extend from bottom surface 60 of button 54, toward the bottom surface of housing 20, as seen in FIG. 7. In the preferred embodiment portion 58 and bottom surface 20 of housing 13 do not come into contact, however, one could, if one desired, design the present invention so that surface 20 and portion 58 do contact each other. The utility of the latter embodiment is beyond the scope of the present invention. In addition, located near the top of left portion 58 of button 54 may be a recess 58a that contacts a bottom surface 25a of top plate 25 of housing 13, as seen in FIGS. 7, 8 and 9. Recess 58a of portion 58 may be implemented so as to co-act with bottom surface 25a in preventing portion 58 from pivoting in an outward motion. Also located on portion 58 may be tooth-like protrusion 58b, as seen in FIG. 5. Tooth-like protrusion 58b may be of any suitable shape known in the art, in the preferred embodiment one implemented a shape that would fit inside of recess 53 of tumbler 36. It is pointed out that recess 53 and tooth-like protrusion 58b may be any suitable shape known in the art, the key element of the arrangement is that tooth-like protrusion 58a should be able to fit inside of recess 53 of tumbler 36, so as to inhibit movement of tumbler 36, until tumbler 36 is activated. Portion 58 and portion 59 are joined at an apex 61, best observed in FIGS. 7, 8 and 9.

Portion 59 of button 54 is generally rectangular in shape, and it extends in a similar manner as that of member 58, that is to say portion 59 also extends from bottom surface 60 of button 54, toward the bottom surface of housing 20, as seen in FIG. 7. Although portion 59 and portion 58 are both generally rectangular in shape, portion 58 is generally slightly broader than portion 59. The reason for the dimension difference, in the preferred embodiment, between portion 58 and portion 59, is twofold. First, portion 58 has to support tooth-like protrusion 58b, and second, portion 59 provides the biasing force required to retain tumbler 36 in a retracted position, hence, portion 59 needs to be more flexible than portion 58. It is this constant force that keeps tumbler 36 in a depressed state. One may however, implement different dimensions for either portion 58 and 59, if one desired.

In another embodiment one may implement two wings 63 and 64 on both side surfaces 61 and 62 respectively of top button portion 56, as in the previously filed United States patent application filed on Mar. 27, 2006 Serial #. Wings 63 and 64 can be of any suitable shape known in the art including but not limited to a square, rectangle, oblong, etc. In that type of embodiment two oblong wings may be implemented. Wings 63 and 64 are allowed to move in a linear back and forth manner, inside slots 68 and 69 respectively, not shown, which are located on sidewalls 14 and 15 respectively. Slots 68 and 69 can be of any suitable shape known in the art including but not limited to square, rectangle, oblong, etc. In the present embodiment two rectangular slots were implemented.

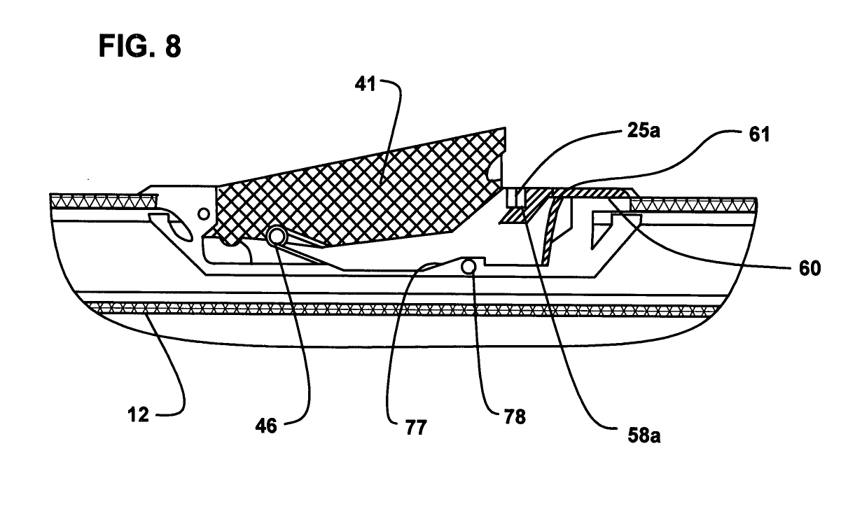

On bottom surface 20 of housing 13 there exists a ramp like protrusion 77 with an aperture 78 at its highest point, as seen in FIGS. 7 and 8. Aperture 78 of protrusion 77 acts as a housing for one of cover plate 14's pins, 79. Pins 79 and pin 80 are located on the bottom of inside surface 26 and the top rear end of inside surface 26 respectively, as seen in FIG. 2. When access to the inside of housing 13 is needed, cover plate 14 can be snapped out of place. When access to inside of housing 13 is no longer required cover plate 14 can be snapped back into place by inserting pin 79 into aperture 78 of protrusion 77, and inserting pin 80 into aperture 81, located on the upper side wall 82 of housing 13, thus closing housing 13.

In another embodiment one may have tumbler 36 with a tooth-like protrusion and button portion 58 with a recess. The functionality of the vent stop would not be altered with this type of embodiment.

When the user desires to activate tumbler 36 so as to cease movement of sliding window member, the user will exert a downward force, greater than that of portion 59, on groove 57, of button 54. This force will cause button 54 to move in a direction opposite that of the stored potential energy of portion 59, thus causing tooth-like protrusion 58b of portion 58 of button 54 to disengage cavity 53 of tumbler 36. When tumbler 36 is free to pivot on axle 38, the upward force of spring 46 will cause tumbler 36 to rotate in an outwardly direction until rectangular guides 30 and 31 meet with bottoms 45(a) and 45(b) of grooves 44(a) and 44(b), at which time stopping surface 53 of tumbler 36 will be exposed, thus preventing sliding window member from opening any further.

As various changes could be made in the above constructions without departing from the scope of the invention, it is intended that all matter contained in the above description shall be interpreted as illustrative and not in a limiting sense. In the view above it will be seen that several objects of the invention are achieved and other advantageous results attained.

I claim:

1. A vent stop for use with a sliding member comprising:
a housing adapted to be disposed in a recess in a window or door, said housing including a cavity, formed by a face plate, a front wall and a rear wall and a first and second sidewall joining said front and rear wall and extending from said face plate;
a tumbler disposed in said cavity, said tumbler having a first end and a second end;
a pivot means for pivotally securing said first end of said tumbler to said housing for movement of said tumbler between an extended position where a front face of said tumbler overlies an edge of the sliding member to prevent movement of the sliding member past the front face of the tumbler, and a retracted position within said cavity so that the sliding member can be moved past the tumbler;
a spring for biasing said tumbler into said extended position;
a button member that has a first position for causing said tumbler to be in an extended position, and a second position for causing said tumbler to be retained in a retracted position;
said button member comprising a top portion and a bottom portion extending from said top portion, said bottom portion having a first member and a second member, said first member having a protruding member extending therefrom that is received by a recess in said front face of said tumbler when said tumbler is in a retracted position to hold said tumbler in said retracted position, said second member of said button is used for biasing said protrusion into said recess when said tumbler is said retracted position.

2. The vent stop according to claim 1 wherein said first member of said bottom portion of said button has a front surface and a rear surface and said protruding member is on said front surface of said first member.

3. The vent stop according to claim 2 wherein said button is moved in a direction toward said sliding member to cause release of said tumbler from said retracted position.

4. The vent stop according to claim 3 wherein said second member of said bottom portion of said button forces said protruding member into said recess in said tumbler when said release member is released by a user and said tumbler is in a retracted position.

5. The vent stop according to claim 4 wherein said button has one or more wings extending into respective recesses in said sidewalls.

6. The vent stop according to claim 5 wherein said button has a contact surface generally in the same plane as the top surface of a face plate.

7. The vent stop according to claim 6 wherein said contact surface has a recess for receiving a member for traversing said button.

8. The vent stop according to claim 1 wherein at least one sidewall is a removable cover plate.

9. A vent stop for use with a sliding member comprising:
a housing adapted to be disposed in a recess in a window or door, said housing including a cavity, formed by a face plate, a front wall and a rear wall and a first and second sidewall joining said front and rear wall and extending from said face plate;
a tumbler disposed in said cavity, said tumbler having a first end and a second end;
a pivot means for pivotally securing said first end of said tumbler to said housing for movement of said tumbler between an extended position where a front face of said tumbler overlies an edge of the sliding member to prevent movement of the sliding member past the front face of the tumbler, and a retracted position within said cavity so that the sliding member can be moved past the tumbler;
a spring for biasing said tumbler into said extended position;
a button member that has a first position for causing said tumbler to be in an extended position, and a second position for causing said tumbler to be retained in a retracted position;
said button member comprising a top portion and a bottom portion extending from said top portion, said bottom portion having a first member and a second member, said first member having a recess thereto for receiving a protruding member from said tumbler when said tumbler is in a retracted position to hold said tumbler in said retracted position, said second member of said button is used for biasing said protrusion into said recess when said tumbler is said retracted position.

10. The vent stop according to claim 9 wherein said first member of said bottom portion of said button has a front surface and a rear surface and said recess is on said front surface of said first member.

11. The vent stop according to claim 10 wherein said button is moved in a direction toward said sliding member to cause release of said tumbler from said retracted position.

12. The vent stop according to claim 11 wherein said second member of said bottom portion of said button forces said protruding member into said recess in said tumbler when said release member is released by a user and said tumbler is in a retracted position.

13. The vent stop according to claim 12 wherein said button has one or more wings extending into respective recesses in said sidewalls.

14. The vent stop according to claim 13 wherein said button has a contact surface generally in the same plane as the top surface of a face plate.

15. The vent stop according to claim 14 wherein said contact surface has a recess for receiving a member for traversing said button.

16. The vent stop according to claim 9 wherein at least one sidewall is a removable cover plate.
